(19) United States
(12) Patent Application Publication
(10) Pub. No.: US 2026/0358522 A1
(43) Pub. Date: Nov. 12, 2026

(54) GROUND FORCE QUALITY CONTROL METHOD AND SYSTEM USING RATIO OF FUNDAMENTAL AND DISTORTED HARMONICS

(71) Applicant: SAUDI ARABIAN OIL COMPANY, Dhahran (SA)

(72) Inventor: Jewoo YOO, Dhahran (SA)

(73) Assignee: ARAMCO OVERSEAS COMPANY B.V., Delft (NL)

(21) Appl. No.: 19/203,034

(22) Filed: May 8, 2025

(51) Int. Cl. G01V 1/30

(52) U.S. Cl. CPC G01V 1/306; G01V 2210/121

(57) ABSTRACT

A method and system for injecting, by a vibroseis system, a first ground force into a subsurface environment based on a pilot sweep. Seismic data is recorded in response to the ground force to obtain a ground force signal. The vibroseis system extracts a fundamental order harmonic signal and higher order harmonic signals from the ground force signal. The vibroseis system further calculates an energy ratio based on the fundamental order harmonic signal and higher order harmonic signals. The energy ratio is compared to a predetermined threshold by the vibroseis system. The vibroseis system injects a second ground force into the subsurface environment based on the comparison of the energy ratio to the predetermined threshold.

### FIELD OF THE DISCLOSURE

The present disclosure relates generally to signal processing and, more particularly, to identifying sources of noise in vibroseis data.

### BACKGROUND OF THE DISCLOSURE

Seismic data acquisition is the first of the three distinct stages of seismic exploration, the other two being seismic data processing and seismic interpretation. Seismic data acquisition requires the use of a seismic source at specified locations for a seismic survey. The energy that travels within the subsurface as seismic waves generated by the source gets recorded at specified locations on the surface by receivers (such as, geophones or hydrophones).

Before seismic data can be acquired, a seismic survey needs to be planned, a process which is commonly referred to as the survey design. This process involves planning regarding various survey parameters to be used, e.g. source type, receiver type, source spacing, receiver spacing, number of source shots, number of receivers in a receiver array (i.e. group of receivers), number of receiver channels in a receiver spread, sampling rate, record length (the specified time for which the receiver actively records the seismic signal), etc. With a designed survey, seismic data can be recorded in the form of seismic traces, also known as seismograms, which directly represent the response of the elastic wave field to velocity and density contrasts across interfaces of layers of rock or sediments as energy travels from a source through the subsurface to a receiver or receiver array.

Vibratory sources (also known as vibroseis) are the commonly used seismic sources in the oil and gas industry. An aspect that sets this type of source apart from explosives or other sources is that it offers direct control over the seismic signal transmitted into the subsurface. In this way, energy can be transmitted into the subsurface over a known range of frequencies over a specified period of time. Vibratory sources typically are host trucks that are mounted with heavy plates which repeatedly hit the ground to transmit seismic energy to the subsurface. Vibratory sources are often employed where vast areas need to be explored and where the acquisition region does not feature densely populated or densely vegetated areas. Highly varying topography also can inhibit the employment of vibratory sources.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present disclosure, a method includes injecting, by a vibroseis system, a first ground force into a subsurface environment based on a pilot sweep. The method includes recording, by the vibroseis system, seismic data in response to the ground force to obtain a ground force signal. The method further includes extracting, by the vibroseis system, a fundamental order harmonic signal and higher order harmonic signals from the ground force signal. The method also includes calculating, by the vibroseis system, an energy ratio based on the fundamental order harmonic signal and higher order harmonic signals. Further, the method includes comparing, by the vibroseis system, the energy ratio to a predetermined threshold. Additionally, the method includes injecting, by the vibroseis system, a second ground force into the subsurface environment based on the comparison of the energy ratio to the predetermined threshold.

According to another embodiment consistent with the present disclosure, a machine-readable storage medium having stored thereon a computer program, the computer program including a routine of set instructions for causing a machine to perform the step of injecting, by a metal plate, a first ground force into subsurface environment based on a pilot sweep. The set of instructions cause the machine to perform the step of receiving seismic data characterizing the first ground force based on the pilot sweep to obtain a first ground force signal. The set of instructions further cause the machine to perform the step of extracting a fundamental order harmonic signal and higher order harmonic signals from the first ground force signal. Further, the set of instructions cause the machine to perform the step of calculating an energy ratio of the ground force signal based on the fundamental order harmonic signal and the higher order harmonic signals. Furthermore, the set of instructions cause the machine to perform the step of comparing the energy ratio of the first ground force to a predetermined threshold. Additionally, the set of instructions cause the machine to perform the step of injecting, by the metal plate, a second ground force into the subsurface environment based on the comparison of the energy ratio to the predetermined threshold.

According to yet another embodiment consistent with the present disclosure, a vibroseis system includes a vibroseis truck. The vibroseis truck has a metal plate configured to couple to a surface of the Earth and inject a ground force based on a pilot sweep. The vibroseis system includes a vibroseis tool, operating on a computing platform, the vibroseis tool including a vibroseis database operable to store the pilot sweep and a predetermined threshold. The vibroseis tool further includes a vibroseis controller operable to receive recorded seismic data characterizing the ground force. The vibroseis tool also includes a signal processor configured to obtain a ground force signal from the recorded seismic data characterizing the ground force. The signal processor is also configured to extract a fundamental order harmonic signal and higher order harmonic signals from the ground force. The signal processor is further configured to compute an energy ratio for the ground force based on the fundamental order harmonic signal and higher order harmonic signals. Additionally, the signal processor is configured to compare the energy ratio to the predetermined threshold.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a block diagram of an example vibroseis system.

FIGS. 2A-2C are examples of signals of the vibroseis system plotted in the time domain.

FIGS. 3A-3C are more examples of signals of the vibroseis system plotted in the time-frequency domain.

FIG. 4 shows two data sets of correlated seismic data in the time domain.

FIG. 5 shows two plots of the correlated seismic data in the frequency spectrum.

FIG. 6 shows more examples of signals of the vibroseis system plotted in the time domain.

FIG. 7 shows an example of signals extracted from a ground force in a frequency plot.

FIG. 8 a flowchart of an example method for separating the fundamental order harmonic signal from the ground force.

FIG. 9 shows two example vibroseis signals plotted in the frequency spectrum.

FIG. 10 shows a plot of distorted harmonics extracted from ground force signals in the frequency spectrum.

FIG. 11 is a graph that illustrates energy ratios of ground forces by trace number.

FIG. 12 illustrates a flowchart of an example method for using a vibroseis system to obtain seismic data according to an embodiment.

FIG. 13 illustrates an example computing system for implementing the vibroseis tool of FIG. 1.

### DETAILED DESCRIPTION

Embodiments of the present disclosure will now be described in detail with reference to the accompanying FIGURES. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying FIGURES may vary without departing from the scope of the present disclosure.

Embodiments in accordance with the present disclosure generally relate to signal processing and, more particularly, to identifying sources of noise in vibroseis data. Specifically, a vibroseis truck can inject a source (e.g., pilot) signal into the ground (e.g., Earth) to generate a ground signal (e.g., force) that is recorded as seismic data. However, the recorded seismic data can include noise, or high frequency components that are not within a frequency range of the data actually intended to be obtained in response to the pilot signal. Unexpected frequencies and data can further reduce the quality of seismic imaging or exploration that relies on this recorded data. This recorded data with undesirable frequencies can be analyzed to determine the source of the undesirable frequencies and employed to determine whether re-exploration is necessary. For example, noise or data outside the intended frequency range can be due to inadequate coupling between the vibroseis truck (e.g., a metal plate) and the ground. Harmonics of the fundamental order and higher order signals are extracted from the recorded signals characterizing the ground force. An energy ratio of the fundamental order harmonic and the remaining signals in the recorded ground signal is generated, which is compared to a predetermined threshold value. For example, if the energy ratio of a recorded signal exceeds a predetermined percentage, re-exploration can occur. Otherwise, if the energy ratio is within the threshold, the quality of the recorded can be confirmed.

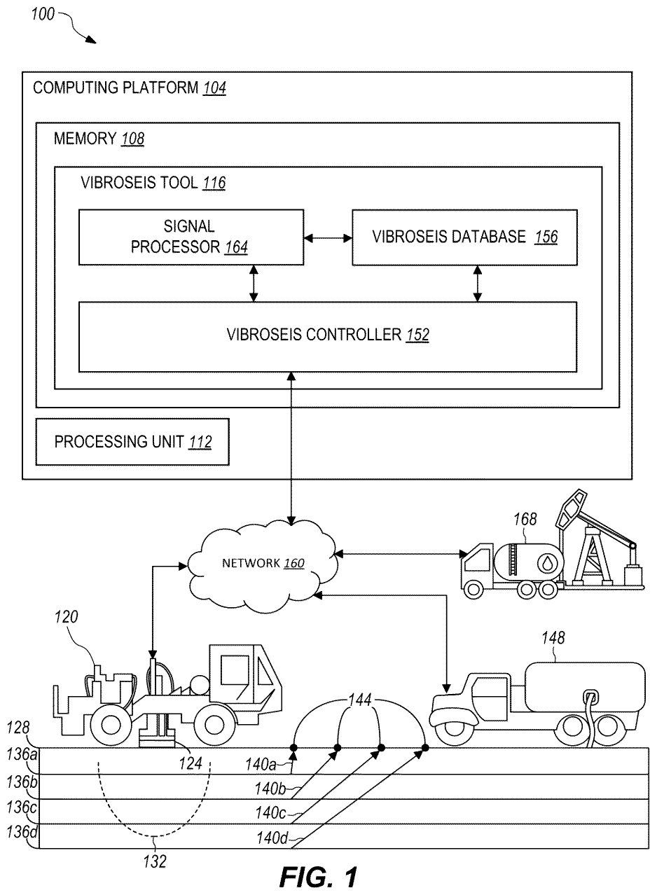

FIG. 1 is a block diagram of an example vibroseis system 100, which is configured to perform seismic data acquisition and processing. Vibroseis system 100 can include a computing platform 104 that further includes a memory 108 for storing machine readable instructions and data. Computing platform 104 can further include a processing unit 112 for accessing the memory 108 and executing the machine-readable instructions. Memory 108 represents a non-transitory machine-readable memory (or other medium), such as random access memory (RAM), a solid state drive, a hard disk drive or a combination thereof. Processing unit 112 can be implemented as one or more processor cores. Computing platform 104 can further include a network interface (not shown), such as a network interface card configured to communicate with other components of vibroseis system 100.

The computing platform 104 can be implemented in a computing cloud. In such a situation, features of the computing platform 104, such as the processing unit 112, the network interface, and the memory 108 can be representative of a single instance of hardware or multiple instances of hardware with applications executing across the multiple instances (e.g., distributed) of hardware (e.g., computers, routers, memory, processors, or a combination thereof). Alternatively, the computing platform 104 can be implemented on a single dedicated server or workstation. Furthermore, in some examples the computing platform 104 can be employed to implement other components of the vibroseis system 100 in a similar manner. However, for purposes of simplification of explanation, only the details of the computing platform 104 are shown.

The memory 108 can further include a vibroseis tool 116 for removing low-order harmonic noise from recorded seismic data. The seismic data can be recorded in response to a seismic device injecting a seismic signal into the ground or Earth. For example, the vibroseis system 100 can include a vibroseis truck 120 equipped with a metal plate 124 that is coupled to the surface 128 of the Earth or ground. Accordingly, the metal plate 124 can be used as a vibrator to inject a ground sweep 132 into the Earth at the surface 128, the ground sweep 132 being a time-variant sinusoidal acoustic signal. Below the surface 128 of the Earth can be layers 136 that each have a different property or formation. For example, a first layer 136a can be a sedimentary layer such as dirt, clay, sand, and/or gravel. A second layer 136b can be another sedimentary layer that has faults, whereas the first layer 136a lacks faults. A third layer 136c can be a subsurface shale formation, which can trap hydrocarbons beneath the shale formation. Thus, a fourth layer 136d can be a hydrocarbon reservoir of oil and/or natural gas.

In response to the ground sweep 132 traveling to each of the layers 136, a change in the layers 136 produces a respective reflective wave 140. Thus, the first layer 136a can produce a first reflective wave 140a, the second layer 136b can produce a second reflective wave 140b, the third layer 136c can produce a third reflective wave 140c, and the fourth layer 136d can produce a fourth reflective wave 140d. Each of these reflective waves 140 can be received by one or more of a plurality of sensors 144. The sensors 144 can be, for example, geophones, hydrophones, accelerometers, fiber-optic sensors, Micro-Electro-Mechanical Sensors (MEMS), or Distributed Acoustic Sensing (DAS) devices that are capable of detecting reflective waves. The type of sensor used can be based on the environment, such as land, shallow water, or even deep water, as well economic considerations.

Further, FIG. 1 illustrates four layers 136, reflective waves 140, and sensors 144 for the purpose of simplicity of explanation. Rather, a different number of layers 136, reflective waves 140, and sensors 144 can be present or produced by the vibroseis system 100. Moreover, the number of layers 136, reflective waves 140, and sensors 144 can be unequal. For example, the layers 136 can be non-uniform, interleaved, and/or sporadic. In another example, a gas hydrate can be lodged in a sedimentary layer such as the first or second layer 136a,b and liquid layers 136 such as the fourth layer 136d can have varying levels of density and fluid composition. Thus, the subsurface formations below the surface 128 can each produce one or more reflective waves 140 that can each be received by one or more sensors 144. Accordingly, the sensors 144 can generate seismic data characterizing the subsurface formations or layers 136 in response to receiving the reflective waves 140. The seismic data can recorded by the sensors 144 or be provided to another device, such as a recording truck 148, that records the seismic data. In some examples, the seismic data can be recorded by the same vehicle or device that produces the ground sweep 132. The recorded seismic data characterizes the ground sweep 132 (e.g., the ground force) injected by the metal plate 124.

The recorded seismic data can be provided to the vibroseis tool 116 by the recording truck 148, such that the vibroseis tool 116 can process the recorded seismic data. Particularly, the vibroseis tool 116 can perform correlation and decorrelation of harmonic signals of the recorded seismic data to extract the fundamental order harmonic signal, as well as higher order (e.g., the first and greater order) harmonic signals of the ground sweep 132. The vibroseis tool 116 can further generate and provide a signal to the vibroseis truck 120 to produce the ground sweep 132, as well as store the recorded seismic data for processing.

The vibroseis tool 116 can further include modules that execute specific operations to assist with these tasks. Specifically, the vibroseis tool 116 can include a vibroseis controller 152, which can be a software program that manages data and/or the flow of data, as well as resources of the vibroseis system 100. The vibroseis controller 152 can receive a pilot wave, or data characterizing the pilot wave, from a vibroseis database 156 of the vibroseis tool 116. Accordingly, the vibroseis controller 152 can provide the pilot wave to the vibroseis truck 120 to generate the ground sweep 132. In response, the vibroseis controller 152 can receive the recorded seismic data from the recording truck 148, for example, and provide the recorded seismic data to the vibroseis database 156. Accordingly, the vibroseis tool 116 can communicate over a network 160, such that the vibroseis controller 152 can communicate with the vibroseis truck 120 and recording truck 148 over the network. For example, network 160 can be an Internet Protocol version 6 (IPV 6) network, 5G broadband network, a 4G Long Term Evolution (LTE) network, or local area network (LAN) compatible with Institute of Electrical and Electronics Engineers (IEEE) 802 Standards.

The vibroseis tool 116 can further includes a signal processor 164, which can receive the recorded seismic data from the vibroseis database 156 or the vibroseis controller 152. The signal processor 164 can extract the fundamental order harmonic signal by correlating and decorrelating harmonic signals of the recorded seismic data. The signal processor 164 can therefore extract the higher order harmonic signals from the ground force using the extracted fundamental order harmonic signal. In an ideal situation, the pilot wave provided by the vibroseis controller 152 to the vibroseis truck 120 matches the ground sweep 132 injected into the Earth at the surface 128. However, inadequate coupling between the plate 124 and the surface 128 results in harmonic distortions in the ground sweep 132. Further, non-linearities associated with mechanical and hydraulic systems of the vibroseis truck 120 can also generate harmonic distortions in the ground sweep 132, which is therefore reflected in the recorded seismic data. Typically, the harmonic distortions are represented in the higher order harmonic signals of the ground force. Accordingly, the signal processor 164 can separate fundamental (e.g., harmonic order of zero) and higher order harmonics (e.g., harmonic orders greater than zero) from the ground sweep 132. Therefore, the signal processor 164 can employ the fundamental and higher order harmonic signals to determine a quality of the ground force and determine whether the metal plate 124 was adequately coupled to the surface 128.

Accordingly, the signal processor 164 can produce and store more accurate seismic data from ground sweeps 132 and recorded seismic data, which can be stored in the vibroseis database 156. Moreover, information is obtained from seismic signals or harmonics that are treated as noise by conventional systems. The increased accuracy of the recorded seismic data can be employed by the vibroseis controller 152 to deploy or alter operations of utility equipment 168. For example, accurate seismic data enables accurate mapping of a size and location of a reservoir (e.g., hydrocarbon reservoir of the fourth layer 136d), such that the vibroseis controller 152 can deploy utility equipment 168 based on the size and location of the reservoir. That is, a smaller reservoir may not support as many wells as a larger reservoir, and a larger reservoir could require additional utility equipment 168 for advanced extraction techniques, such as horizontal drilling.

Additionally, accurate seismic data enables accurate reservoir characterization, such as porosity, permeability, and the presence of faults, which can impact how the vibroseis controller 152 deploys utility equipment 168. That is, a reservoir without faults can have wells placed uniformly and employ standard recovery techniques, whereas a reservoir with faults requires targeted well placement to reach isolated pockets of hydrocarbons. Further, accurate seismic data enables accurate cost management, reductions in unnecessary drilling that impacts the environment, and mitigation of risks associated with drilling and extraction. In later stages of recovery, seismic data is also employed to monitor changes in reservoir characteristics over time, such that the vibroseis controller 152 can adjust extraction techniques and operations by utility equipment 168 based on the changes indicated by the seismic data.

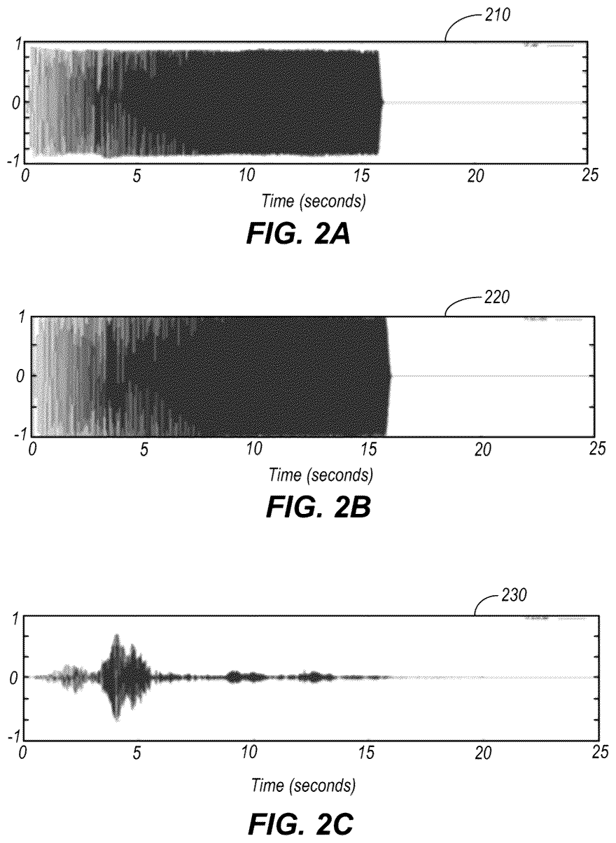

FIGS. 2A-C are example signals of the vibroseis system (e.g., vibroseis system 100 of FIG. 1) in the time domain. Specifically, FIG. 2A is an example pilot sweep 210, which can be the pilot wave that is provided by the vibroseis controller 152 to the vibroseis truck 120 of FIG. 1. That is, the pilot sweep 210 can be data characterizing the pilot wave stored in a vibroseis database 156 of the vibroseis tool 116 of FIG. 1. As illustrated, the pilot sweep 210 can last for approximately 16 seconds and oscillate between 1 and −1 about a zero reference. In some examples, the pilot sweep 210 can be as short as 5 seconds or as long as 32 seconds. In other examples, the pilot sweep is generated by a seismic survey designer.

As previously stated, the pilot sweep 210 is the signal provided to a vibroseis truck 120 to be injected into a surface (e.g., surface 128 of FIG. 1) via a metal plate (e.g., plate 124). Accordingly, the metal plate can be oscillated at the frequency and duration of the pilot sweep 210 as illustrated in FIG. 2A. However, the wave provided to the ground is not equal to the pilot sweep 210 because of non-linearities associated with the coupling of the metal plate to the ground, as well as the mechanical and hydraulic systems of the vibroseis truck. Rather, FIG. 2B illustrates a ground sweep 220, which can be the ground sweep 132 of FIG. 1. That is, the ground sweep 220 is the signal actually provided to the surface of the Earth. Thus, the ground sweep 220 is not equal to the pilot sweep 210 because of the non-linearities associated with the vibroseis truck and metal plate. Although the ground sweep 220 can be similar to the pilot sweep 210, for example have the same duration, the ground sweep 220 includes the non-linearities as noise.

FIG. 2C illustrates recorded seismic data 230, which can be the recorded seismic data provided to the vibroseis controller 152 by the recording truck 148 or the sensors 144 of FIG. 1. As illustrated, the recorded seismic data 230 can be a sinusoidal response to the ground sweep 220, such that the recorded seismic data is a sinusoidal signal that has the same duration. However, the recorded seismic data 230 is a function of the ground sweep 220 reflecting off of layers 136 beneath the surface 128, such as the reflective waves 140 of FIG. 1. Furthermore, the recorded seismic data 230 can be raw, such that the recorded seismic data 230 has not been correlated by the signal processor 164 of FIG. 1. Additionally, the recorded seismic data 230 and sweeps 210, 220 can be converted to a time-frequency domain.

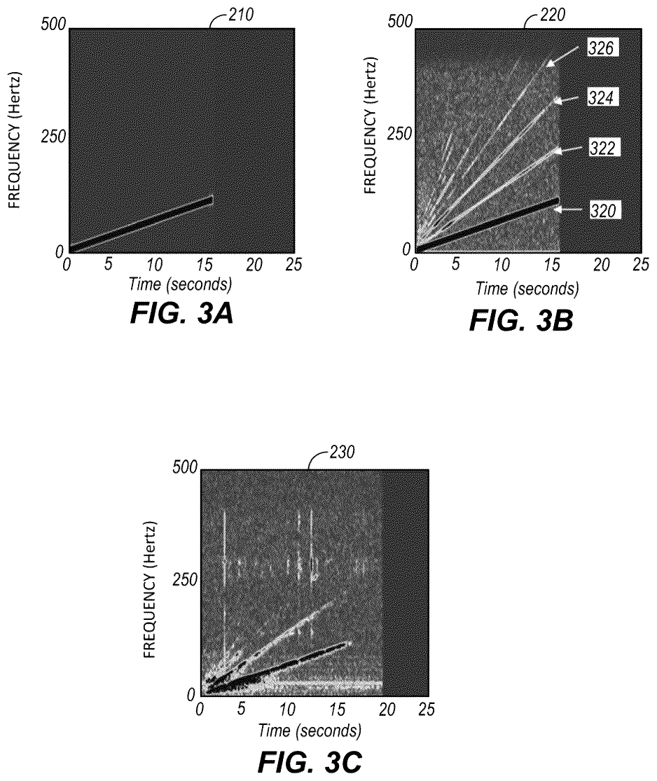

FIGS. 3A-C are example signals of the vibroseis system (e.g., vibroseis system 100 of FIG. 1) plotted in the time-frequency domain showing time in seconds along a horizontal axis and frequency (Hertz) along a vertical axis. For example, FIG. 3A can be the pilot sweep 210 converted from the time domain of FIG. 2A to the time-frequency domain via a Gabor transformation. As illustrated, the pilot sweep 210 of the time-frequency domain has the same duration as the pilot sweep in the time domain (e.g., approximately 16 seconds), but has a linearly increasing frequency over that time. The frequency range can be computed from the sampling rate, such that the frequency range is the Nyquist frequency. Here, the sampling rate is 0.001 seconds, such that the frequency range is 500 Hz. Similarly, FIG. 3B is the ground sweep 220 converted from the time domain of FIG. 2B to the time-frequency domain via the Gabor transform. As illustrated in FIG. 3B, the ground sweep 220 converted to the time-frequency domain renders a plurality of signals, which are harmonic signals. For example, a fundamental order harmonic signal (H₀) 320 of the ground sweep 220 of FIG. 2B is illustrated as having a similar plot to the ground sweep 220 in the time domain of FIG. 2B. However, the plurality of signals further includes a first order harmonic signal (H₁) 322, a second order harmonic signal (H₂) 324, and a third order harmonic signal (H₃) 326. Other higher order harmonics of FIG. 3B are difficult to visualize because of noise or disturbances in the ground sweep 220.

FIG. 3C illustrates the recorded seismic data 230 converted from the time domain of FIG. 2C to the time-frequency domain. Because the recorded seismic data 230 is in response to the ground sweep 220, FIG. 3C also illustrates a plurality of signals including the fundamental order harmonic signal 320 and the first order harmonic signal 322. Again, however, the higher order harmonic signals are difficult to visualize because of noise.

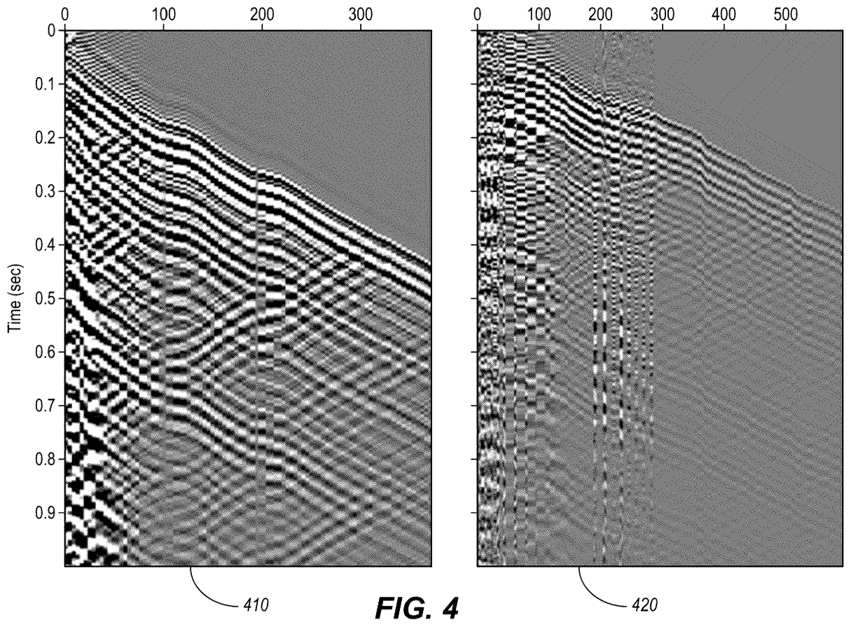

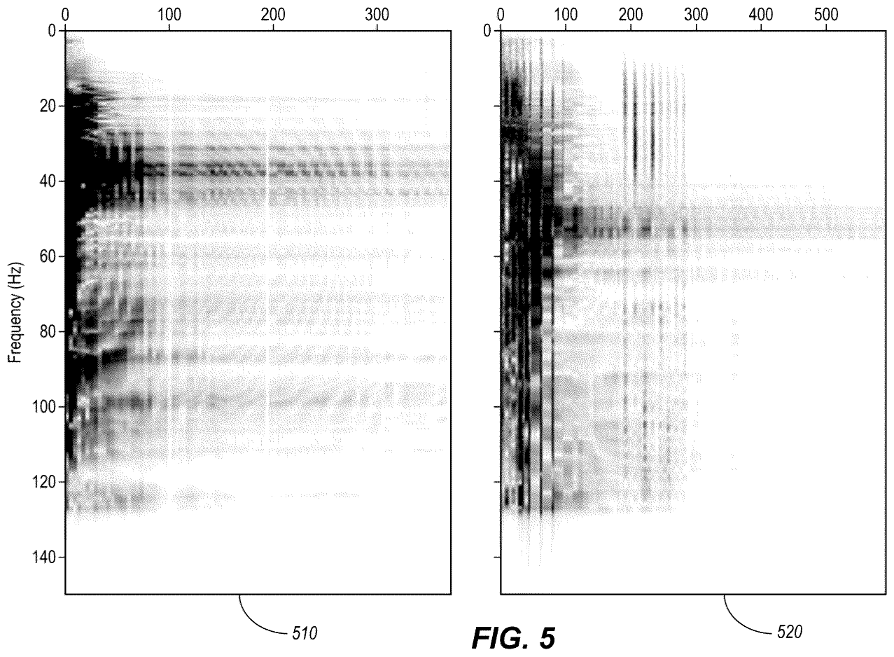

FIG. 4 shows two data sets 410, 420 that illustrate correlated seismic data in the time domain. The correlated seismic data can be obtained through correlation of recorded seismic data (e.g., the recorded seismic data 230) and a pilot sweep (e.g., the pilot sweep 210 of FIG. 2). Accordingly, a first set of correlated seismic data 410 is created in response to a first pilot sweep, which is correlated with resultant recorded seismic data. The first pilot sweep can be injected to the Earth at a given location (e.g., the surface 128). Similarly, a second set of correlated seismic data 420 is created in response to a second pilot sweep, which is correlated with resultant recorded seismic data from the second pilot sweep. The second pilot sweep can be the same as the first pilot sweep, and injected at the same given location as the first pilot sweep. However, the first set of correlated seismic data 410 is noticeably different than the second set of correlated seismic data 420, even though the first pilot sweep and second pilot sweep are the same and injected at the same location. In another example, FIG. 5 illustrates two data sets 510, 520 of the correlated seismic data in the frequency domain. In the frequency domain shown in data sets 510, 520, there is a more noticeable difference in the frequency components of the first set of correlated seismic data 510 compared to the second set of correlated seismic data 520. That is, the second set of correlated seismic data 520 exhibits a higher frequency energy compared to expected frequency band data for the given location in the first set of data 510. Thus, the second set of correlated seismic data 520 is considered a distorted signal, such that the second set of correlated seismic data 520 is regarded as diminished where uniform frequency band data is anticipated across the given location.

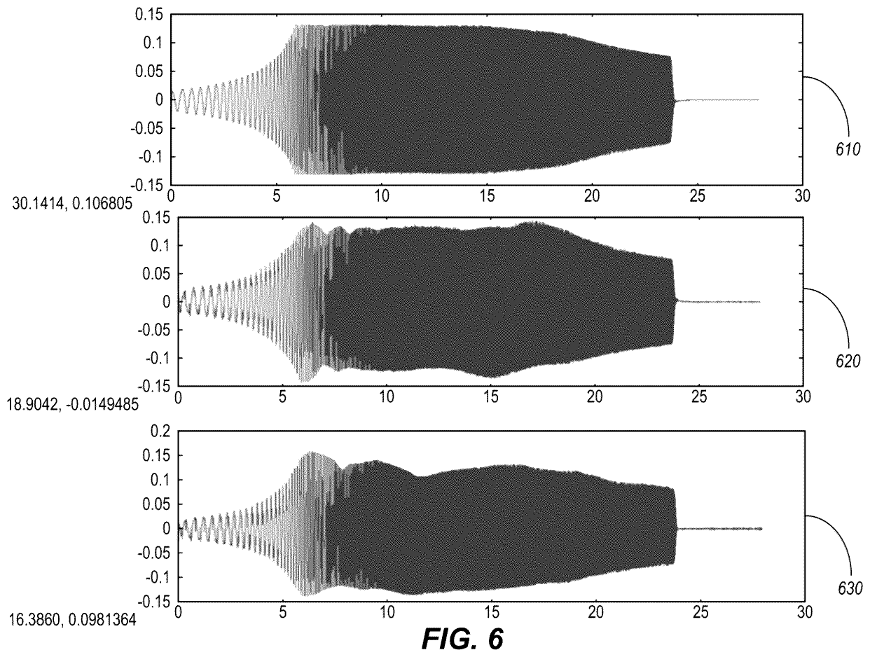

A reason for a distorted signal could be, for example, inadequate coupling between the vibroseis truck (e.g., the vibroseis truck 120 of FIG. 1) and the surface of the Earth. Although the same pilot sweep is employed to render the first and second sets of correlated seismic data 410,420, it is possible to observe that the respective peak frequencies the sets of data are different. The cause of the distorted signal can be determined by comparing the recorded ground sweeps caused by the respective pilot sweeps. FIG. 6 illustrates example vibroseis signals in the time domain, including a pilot sweep 610 (e.g., the pilot sweep 210 of FIG. 2). The pilot sweep 610 can be used to generate a ground sweep (e.g., the ground sweep 132 of FIG. 1), which is recorded as ground force (e.g., by the recording truck 148 of FIG. 1). Accordingly, the same pilot sweep 610 can produce a first ground force 620 and a second ground force 630. In some examples, the first ground force 620 can correspond to the first set of correlated seismic data 410 and the second ground force 630 can correspond to the second set of correlated seismic data 420.

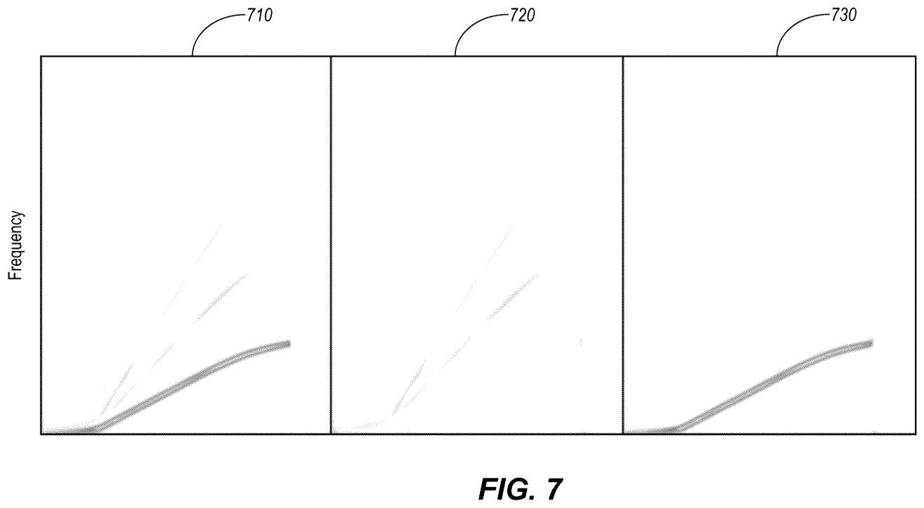

FIG. 7 illustrates a ground force 710, such as the second ground force 630, in the frequency domain. When the ground force 710 is expressed in the frequency domain, higher frequency components can be revealed, which can further indicate a distorted signal. To determine a source of the high frequency components, the ground force 710 is separated into harmonic signals. For example, the distorted harmonics 720 can be isolated to extract the fundamental order harmonic signal 730. Specifically, the ground force 710 can expressed with the following expression (1):

G=H₀+H₁+H₂+H₃+Hᵢ (1)

where G is the ground force 710, Hᵢ represents the ith order of harmonic signal where “i” is an integer greater than or equal to zero, the fundamental order harmonic signal 730 being the 0^{th} order harmonic signal and the distorted harmonics 720 being greater than the 0^{th} order harmonic signal.

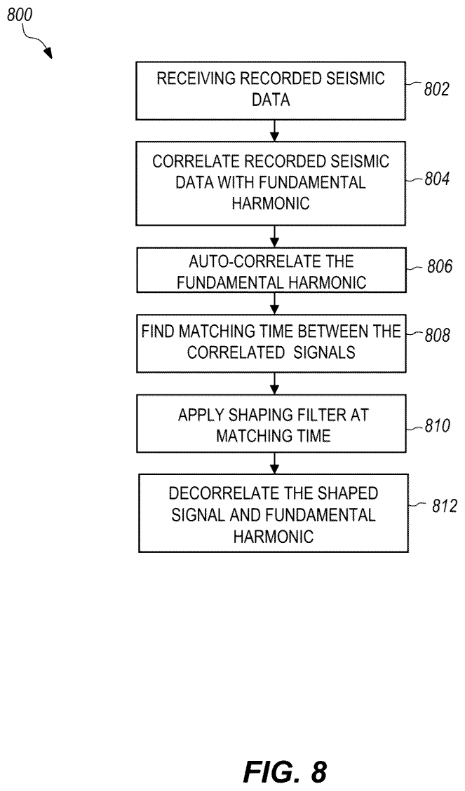

In view of the structural and functional features described above, example methods will be better appreciated with reference to FIGS. 1-7. While, for purposes of simplicity of explanation, the example methods of FIG. 8 is shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 8 illustrates a flowchart of an example method 800 for separating the fundamental order harmonic signal (e.g., the fundamental order harmonic signal 730 of FIG. 7) from the ground force (e.g., the ground force 710 of FIG. 7). The method 800 can be implemented by the vibroseis tool 116, and more specifically the signal processor 164, as shown in FIG. 1. Thus, reference can be made to the example of FIGS. 1-7 in the example of FIG. 8. The method 800 can begin at 802 by receiving recorded seismic data (e.g., recorded seismic data 230 of FIGS. 2C and 3C) via the signal processor. For example, the recorded seismic data can be provided to the signal processor by a vibroseis controller (e.g., vibroseis controller 152 of FIG. 1) in response to the vibroseis controller receiving the recorded seismic data from a recording truck (e.g., recording truck 148 of FIG. 1). Particularly, the recorded seismic data is received by the recording truck in response to a vibroseis truck (e.g., vibroseis truck 120) injecting a ground sweep (e.g., ground sweep 132 of FIG. 1 and ground sweep 220 of FIGS. 2C and 3C) in a surface (e.g., surface 128) of the Earth via a metal plate (e.g., the metal plate 124 of FIG. 1). The ground sweep can be injected by the vibroseis truck in response to receiving a pilot sweep (e.g., pilot sweep 210 of FIG. 2A), which can be provided by the vibroseis controller. Accordingly, the vibroseis controller can store each of the pilot sweep, ground sweep (e.g., the ground force), and recorded seismic data in a vibroseis database 156.

At 804, the signal processor correlates the recorded seismic data and the fundamental order harmonic signal of the ground force (e.g., G⊗H₀), where ⊗ indicates correlation. The fundamental harmonic signal of the ground force is therefore isolated from other harmonic signals (e.g., the distorted harmonics 720 of FIG. 7). At 806, the signal processor auto-correlates the fundamental order harmonic signal (e.g., H₀⊗H₀), which transforms the fundamental order harmonic signal to an impulse at a specific time. At 808, the signal processor searches and selects a time that has a greatest match between the fundamental order harmonic signal correlated with the ground force and the auto-correlated fundamental order harmonic signal (e.g., Tₐₘₚ). Accordingly, the signal processor can employ the following expression (2) to compute Tₐₘₚ:

Tₐₘₚ=argmax {(G⊗H₀)⊗(H₀⊗H₀)} (2)

wherein argmax computes the value (e.g., time) that maximizes Tₐₘₚ as a function of the harmonic signal correlated with the ground force (e.g., G⊗H₀) further correlated with the autocorrelated harmonic signal (e.g., H₀⊗H₀). Thus, Tₐₘₚ is a point in time where the harmonic signal correlated with the ground force and the auto-correlated fundamental order harmonic signal have the greatest concordance.

The signal processor can apply a shaping filter W that creates an impulse by exponentially attenuating a signal along both positive and negative time axes based on a matching time point T. Thus, at 810, the signal processor produces a shaped signal by applying the shaping filter to the harmonic signal correlated with the ground wave at the time point defined by the autocorrelated fundamental order harmonic signal Tₐₘₚ. For example, the signal processor can employ the following expression (3) to compute the shaped signal:

W_{T}_{ₐₘₚ}(G⊗H₀) (3)

At 812, the signal processor decorrelates the shaped signal (e.g., W_{T}_{ₐₘₚ}(G⊗H₀) and the harmonic signal to produce a de-correlated signal. The de-correlated signal can be H′₀, the fundamental order harmonic signal 730. Thus, the signal processor can extract the fundamental order harmonic signal 730 from the ground force 710 using the method 800. The extracted fundamental order harmonic signal H′₀ can be calculated according to the following expression (4):

H′₀=decorr(W_{T}_{ₐₘₚ}(G⊗H₀),H₀) (4)

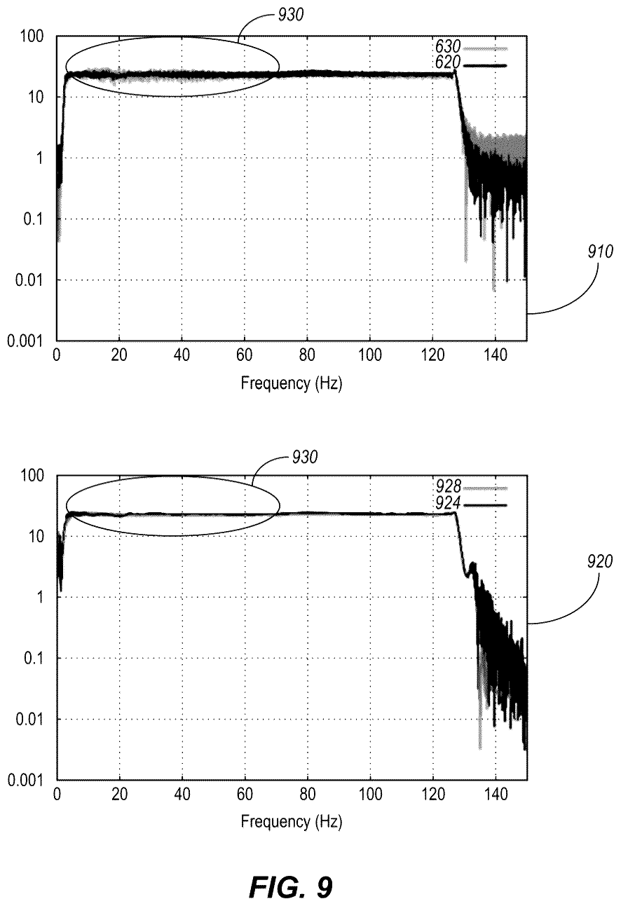

FIG. 9 illustrates a vibroseis signals in the frequency spectrum. Specifically, the first ground force (e.g., the first ground force 620 of FIG. 6) and a second ground force (e.g., the second ground force 630 of FIG. 6) are illustrated in the frequency spectrum in a first plot 910. A second plot 920 illustrates the extracted fundamental order harmonic signals (e.g., the fundamental order harmonic signal 730 of FIG. 7) for the first and second ground forces 620,630. Accordingly, the second plot 920 has a first fundamental order harmonic signal 924 that corresponds to the first ground force 620, as well as a second fundamental order harmonic signal 928 that corresponds to the second ground force 630. Both the first and second plots 910,920 have a problematic frequency range 930. Specifically, the first plot 910 includes the second ground force 630 that has higher frequencies in the problematic frequency range. These higher frequencies are not present in the first ground force 620 in the first plot. Moreover, the fundamental order harmonic signals 924,928 have similar frequencies in the problematic frequency range 930.

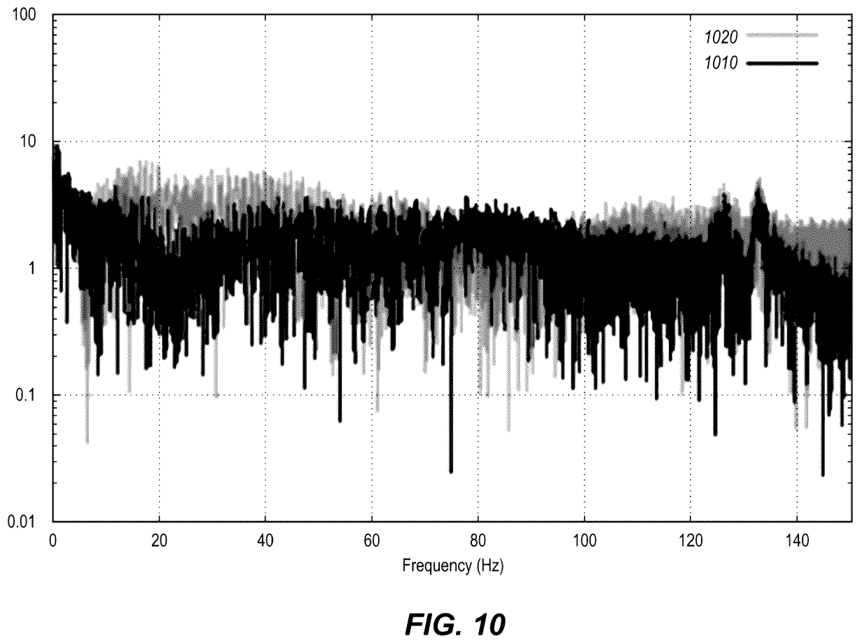

FIG. 10 illustrates the distorted harmonics (e.g., the distorted harmonics 720 of FIG. 7) for the first and second ground forces (e.g., the first and second ground forces 620,630 of FIG. 6) in the frequency spectrum. Specifically, FIG. 10 illustrates the frequency spectrum of harmonic signals of the first order or higher. These distorted harmonics can be obtained by removing the fundamental order harmonic signal (e.g., the fundamental order harmonic signal 730) from the ground force signal (e.g., the ground force 710 of FIG. 7). Thus, FIG. 10 illustrates a first distorted signal 1010 that corresponds to the first ground force 620 and a second distorted signal 1020 that corresponds to the second ground force 630. In FIG. 10, the second distorted signal 1020 has greater energy in the problematic frequency range (e.g., the problematic frequency range 930) compared to the first distorted signal 1010.

During seismic exploration with the vibroseis truck, it can be confirmed that the cause of high-order distortion is imperfect coupling between the metal plate of the vibroseis truck and the ground (e.g., surface 128). As illustrated in FIG. 9, these high-order distortions do not impact the fundamental order harmonic signal, but do impact the recorded seismic data. Thus, the quality of the ground forces can be checked by acquiring data of the ground forces. Specifically, quality of the ground forces can be determined by comparing the fundamental order harmonic signal with the higher order harmonic signals of a ground force.

To assess the quality of a signal, specifically the ground force, the signal processor can employ an energy ratio. Specifically, the energy ratio is the ratio of the fundamental order harmonic signal to the remaining harmonic (e.g., distorted) signals of the ground force. The energy ratio can be computed with a signal processor (e.g., the signal processor 162 of FIG. 1) using the following expression (4):

$$k = \frac{\sqrt{{\sum }_{f} {( G - {H}_{0} ( f ) )}^{2}}}{\sqrt{{{\sum }_{f} {H}_{0} ( f ) )}^{2}}} \times 100 \qquad ( 4 )$$

where k is the energy ratio expressed as a percentage and f is the frequency range of the sweep signal injected from the vibroseis truck into the ground. During exploration operations at a site or surface, the real-time energy ratio is computed using the ground force and pilot sweep based on the above expression (4). If the energy ratio surpasses a predetermined threshold, the vibroseis tool can determine that the data is flawed. Accordingly, the vibroseis tool can decide to move the vibroseis truck and conduct re-exploration to enhance quality of the acquired seismic data. In some examples, the predetermined threshold for k can be 10%, such that if the ground force has an energy ratio of 10% or more, the vibroseis tool can conduct re-exploration.

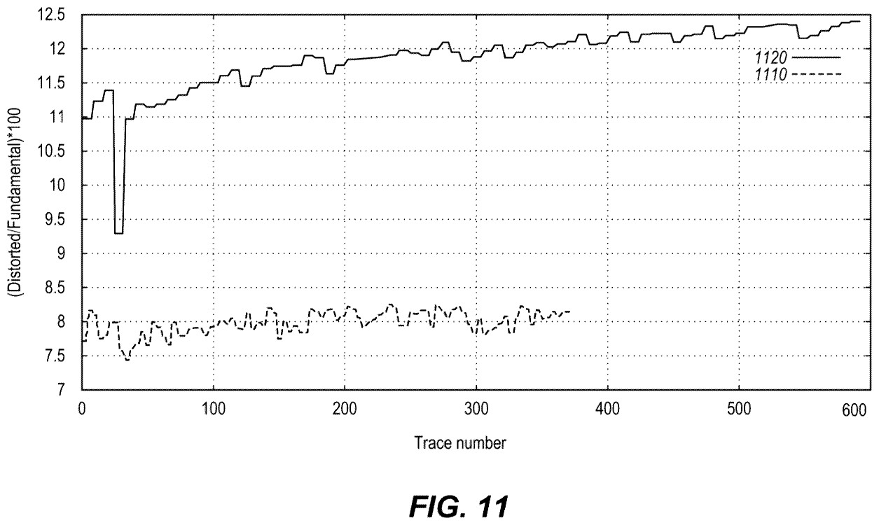

FIG. 11 shows a graph of an example of energy ratio (distorted/fundamental) for the first and second ground forces 620, 630. For clarity, a vertical axis shows an energy ratio percentage value ((distorted/fundamental)*100) and a horizontal axis is a trace number. Accordingly, a first energy ratio 1110 corresponds to the first ground force 620 and a second energy ratio corresponds to the second ground force 630. As illustrated, the first energy ratio 1210 stays below about 8.5%. Accordingly, the first energy ratio 1110 would stay below a 10% energy ratio threshold, thereby indicating that the first pilot sweep associated with the first energy ratio and ground force (e.g., the first ground force 620) is acceptable. Accordingly, the recorded seismic data and resulting first set of correlated seismic data (e.g., the first set of correlated seismic data 410 of FIG. 4) can be employed to image the geological formations below the surface (e.g., the surface 128 of FIG. 1). Conversely, the second energy ratio 1120 is generally above an energy ratio of 11%. That is, the second energy ratio 1120 begins at above the predetermined threshold energy ratio of 10%. Because the second energy ratio 1120 surpasses the predetermined threshold energy ratio of 10%, the vibroseis tool (e.g., the vibroseis tool 116 of FIG. 1) can determine that the data collected from the second pilot sweep associated with the second energy ratio is flawed. Accordingly, the recorded seismic data and resulting second set of correlated seismic data (e.g., the second set of correlated seismic data 420 of FIG. 4) can be excluded from imaging the geological formations below the surface. Instead, the vibroseis tool can reposition the vibroseis truck to conduct a third pilot sweep matching the second pilot sweep. Accordingly, the pilot sweep can be re-injected into the ground until quality of the final acquired data reaches an acceptable quality as determined by the energy ratio threshold.

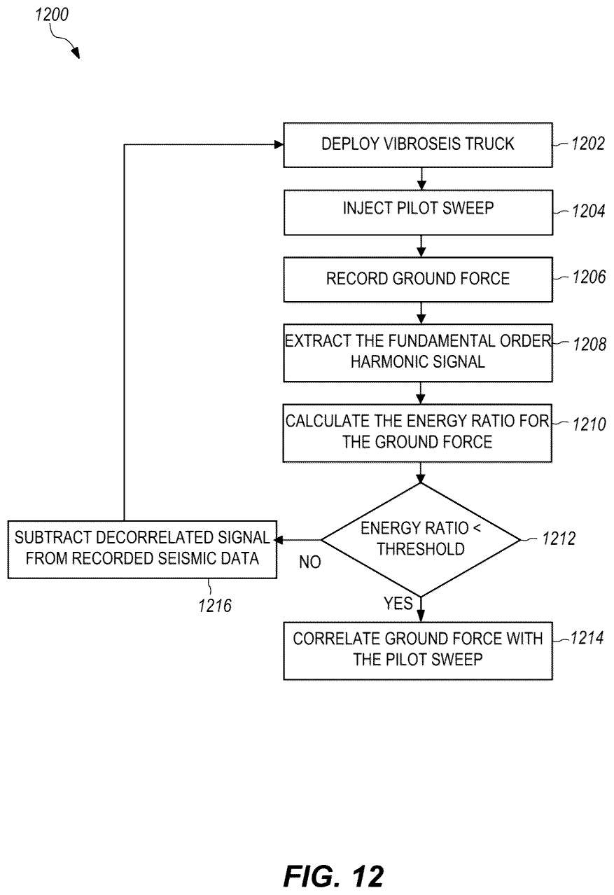

In view of the structural and functional features described above, example methods will be better appreciated with reference to FIGS. 1-11. While, for purposes of simplicity of explanation, the example method of FIG. 12 are shown and described as executing serially, it is to be understood and appreciated that the present examples are not limited by the illustrated order, as some actions could in other examples occur in different orders, multiple times and/or concurrently from that shown and described herein. Moreover, it is not necessary that all described actions be performed to implement the methods, and conversely, some actions may be performed that are omitted from the description.

FIG. 12 is an example of a method 1200 for performing exploration based on real-time collection and analysis of energy ratios. The method 1200 can be implemented by a vibroseis system 100, as shown in FIG. 1. Thus, reference can be made to the example of FIGS. 1-11 in the example of FIG. 12. The method 1200 can begin at 1202 by deploying a vibroseis truck 120 to a given location of a surface 128. At 1204, the vibroseis truck 120 can inject a pilot sweep into the surface 128 via a metal plate 124.

At 1206, a recording truck 148 records a ground force (e.g., the ground sweep 132 of FIG. 1; the first ground force 620 of FIG. 6), which is received by the vibroseis tool 116 of the vibroseis system 100. More specifically, the vibroseis controller 152 can receive the recorded ground force and provide the ground force data to the signal processor 164 of the vibroseis tool 116. At 1208, the signal processor of the vibroseis tool 116 can extract the harmonic signals from the recorded ground force. Specifically, at 1208, the signal processor can perform the method 800 to extract the fundamental order harmonic signal of the recorded ground force. In an example, the first fundamental order harmonic signal 924 of FIG. 9 can be extracted from the first ground force 620 of FIGS. 6 and 9. Thus, the distorted harmonics (e.g., the distorted harmonics of FIG. 7) can be extracted from the first ground force 620 using the first fundamental order harmonic signal. Thus, at 1208, the signal processor can extract these distorted harmonics (e.g., the distorted harmonics 720 of FIG. 7) by removing the fundamental order harmonic signal (e.g., the fundamental order harmonic signal 730) from a ground force signal (e.g., the ground force 710 of FIG. 7).

At 1210, the signal processor calculates the energy ratio for the ground force signal. That is, for the first ground force signal, the ratio of distorted harmonics over the fundamental order harmonic signal is calculated by the signal processor. At 1212, the signal processor compares the computed energy ratio with a predetermined threshold. The predetermined threshold can be calculated by the signal processor, or can be provided by an operator. If the energy ratio is below the predetermined threshold (“YES”), the recorded ground force is correlated with the pilot sweep and employed to generate subsurface data (e.g., images) at 1214. However, if the energy ratio is above the predetermined threshold (“NO”), the recorded ground force is not correlated with the pilot sweep and employed to generate subsurface data. Instead, the vibroseis controller instructs the vibroseis truck to re-position for re-exploration at 1216. In response, the method returns to 1202 to redeploy the vibroseis truck to the new position. The new position can be slightly different than the original position, which is intended to correct for inadequate coupling between the metal plate and the surface.

The method 1200 can be repeated for the same position to collect vibroseis data for a given position on the surface to accurately image a subsurface environment. Furthermore, the method 1200 can be implemented with a vibroseis system (e.g., the vibroseis system 100 of FIG. 1), which can be located at an exploration site. Therefore, determinations of whether to conduct re-exploration based on an energy ratio is completed in real-time. In some examples, the vibroseis tool can be implemented using edge computing devices positioned in, or proximal to a vibroseis truck.

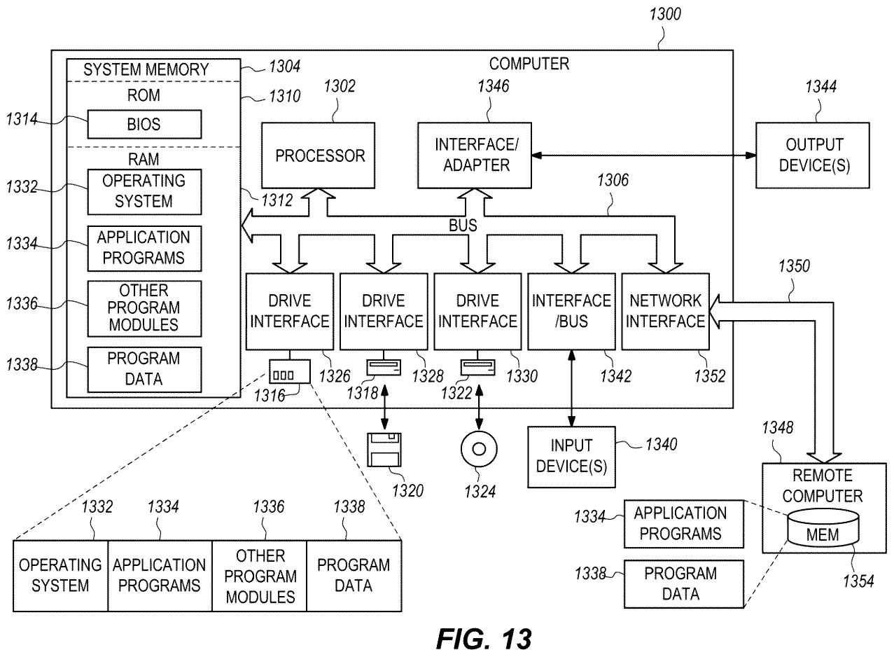

In view of the foregoing structural and functional description, those skilled in the art will appreciate that portions of the embodiments may be embodied as a method, data processing system, or computer program product. Accordingly, these portions of the present embodiments may take the form of an entirely hardware embodiment, an entirely software embodiment, or an embodiment combining software and hardware, such as shown and described with respect to the computer system of FIG. 13. Furthermore, portions of the embodiments may be a computer program product on a computer-readable storage medium having computer readable program code on the medium. Any non-transitory, tangible storage media possessing structure may be utilized including, but not limited to, static and dynamic storage devices, volatile and non-volatile memories, hard disks, optical storage devices, and magnetic storage devices, but excludes any medium that is not eligible for patent protection under 35 U.S.C. § 101 (such as a propagating electrical or electromagnetic signals per se). As an example and not by way of limitation, computer-readable storage media may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. A computer-readable non-transitory storage medium may be volatile, nonvolatile, or a combination of volatile and non-volatile, as appropriate.

Certain embodiments have also been described herein with reference to block illustrations of methods, systems, and computer program products. It will be understood that blocks and/or combinations of blocks in the illustrations, as well as methods or steps or acts or processes described herein, can be implemented by a computer program comprising a routine of set instructions stored in a machine-readable storage medium as described herein. These instructions may be provided to one or more processors of a general purpose computer, special purpose computer, or other programmable data processing apparatus (or a combination of devices and circuits) to produce a machine, such that the instructions of the machine, when executed by the processor, implement the functions specified in the block or blocks, or in the acts, steps, methods and processes described herein.

These processor-executable instructions may also be stored in computer-readable memory that can direct a computer or other programmable data processing apparatus to function in a particular manner, such that the instructions stored in the computer-readable memory result in an article of manufacture including instructions which implement the function specified. The computer program instructions may also be loaded onto a computer or other programmable data processing apparatus to cause a series of operational steps to be performed on the computer or other programmable apparatus to realize a computer implemented process such that the instructions which execute on the computer or other programmable apparatus provide steps for implementing the functions specified in flowchart blocks that may be described herein.

In this regard, FIG. 13 illustrates one example of a computer system 1300 that can be employed to execute one or more embodiments of the present disclosure. Computer system 1300 can be implemented on one or more general purpose networked computer systems, embedded computer systems, routers, switches, server devices, client devices, various intermediate devices/nodes or standalone computer systems. Additionally, computer system 1300 can be implemented on various mobile clients such as, for example, a personal digital assistant (PDA), laptop computer, pager, and the like, provided it includes sufficient processing capabilities.

Computer system 1300 includes processing unit 1302, system memory 1304, and system bus 1306 that couples various system components, including the system memory 1304, to processing unit 1302. System memory 1304 can include volatile (e.g. RAM, DRAM, SDRAM, Double Data Rate (DDR) RAM, etc.) and non-volatile (e.g. Flash, NAND, etc.) memory. Dual microprocessors and other multi-processor architectures also can be used as processing unit 1302. System bus 1306 may be any of several types of bus structure including a memory bus or memory controller, a peripheral bus, and a local bus using any of a variety of bus architectures. System memory 1304 includes read only memory (ROM) 1310 and random access memory (RAM) 1312. A basic input/output system (BIOS) 1314 can reside in ROM 1310 containing the basic routines that help to transfer information among elements within computer system 1300.

Computer system 1300 can include a hard disk drive 1316, magnetic disk drive 1318, e.g., to read from or write to removable disk 1320, and an optical disk drive 1322, e.g., for reading CD-ROM disk 1324 or to read from or write to other optical media. Hard disk drive 1316, magnetic disk drive 1318, and optical disk drive 1322 are connected to system bus 1306 by a hard disk drive interface 1326, a magnetic disk drive interface 1328, and an optical drive interface 1330, respectively. The drives and associated computer-readable media provide nonvolatile storage of data, data structures, and computer-executable instructions for computer system 1300. Although the description of computer-readable media above refers to a hard disk, a removable magnetic disk and a CD, other types of media that are readable by a computer, such as magnetic cassettes, flash memory cards, digital video disks and the like, in a variety of forms, may also be used in the operating environment; further, any such media may contain computer-executable instructions for implementing one or more parts of embodiments shown and described herein.

A number of program modules may be stored in drives and RAM 1312, including operating system 1332, one or more application programs 1334, other program modules 1336, and program data 1338. In some examples, the application programs 1334 can include a vibroseis tool, vibroseis controller, vibroseis database, and signal processor. The program data 1338 can include a pilot sweep, ground sweep, and seismic data in various domains, as well as seismic data processed by the signal processor. The application programs 1334 and program data 1338 can include functions and methods programmed to calculate energy ratios of ground forces and deploy vibroseis systems, such as shown and described herein.

A user may enter commands and information into computer system 1300 through one or more input devices 1340, such as a pointing device (e.g., a mouse, touch screen), keyboard, microphone, joystick, game pad, scanner, and the like. For instance, the user can employ input device 1340 to edit or modify select an order of the harmonic signals, adjust a threshold value employed by the signal processor for decorrelation. These and other input devices 1340 are often connected to processing unit 1302 through a corresponding port interface 1342 that is coupled to the system bus, but may be connected by other interfaces, such as a parallel port, serial port, or universal serial bus (USB). One or more output devices 1344 (e.g., display, a monitor, printer, projector, or other type of displaying device) is also connected to system bus 1306 via interface 1346, such as a video adapter.

Computer system 1300 may operate in a networked environment using logical connections to one or more remote computers, such as remote computer 1348. Remote computer 1348 may be a workstation, computer system, router, peer device, or other common network node, and typically includes many or all the elements described relative to computer system 1300. The logical connections, schematically indicated at 1350, can include a local area network (LAN) and/or a wide area network (WAN), or a combination of these, and can be in a cloud-type architecture, for example configured as private clouds, public clouds, hybrid clouds, and multi-clouds. When used in a LAN networking environment, computer system 1300 can be connected to the local network through a network interface or adapter 1352. When used in a WAN networking environment, computer system 1300 can include a modem, or can be connected to a communications server on the LAN. The modem, which may be internal or external, can be connected to system bus 1306 via an appropriate port interface. In a networked environment, application programs 1334 or program data 1338 depicted relative to computer system 1300, or portions thereof, may be stored in a remote memory storage device 1354.

Embodiments disclosed herein include:
A. A method comprising: injecting, by a vibroseis system, a first ground force into a subsurface environment based on a pilot sweep; recording, by the vibroseis system, seismic data in response to the first ground force to obtain a ground force signal; extracting, by the vibroseis system, a fundamental order harmonic signal and higher order harmonic signals from the ground force signal; calculating, by the vibroseis system, an energy ratio based on the fundamental order harmonic signal and higher order harmonic signals; comparing, by the vibroseis system, the energy ratio to a predetermined threshold; and injecting, by the vibroseis system, a second ground force into the subsurface environment based on the comparison of the energy ratio to the predetermined threshold.
B. A machine-readable storage medium having stored thereon a computer program, the computer program comprising a routine of set instructions for causing a machine to perform the steps of: injecting, by a metal plate, a first ground force into subsurface environment based on a pilot sweep; receiving seismic data characterizing the first ground force based on the pilot sweep to obtain a first ground force signal; extracting a fundamental order harmonic signal and higher order harmonic signals from the first ground force signal; calculating an energy ratio of the first ground force signal based on the fundamental order harmonic signal and the higher order harmonic signals; comparing the energy ratio of the first ground force signal to a predetermined threshold; and injecting, by the metal plate, a second ground force into the subsurface environment based on the comparison of the energy ratio to the predetermined threshold.
C. A vibroseis system comprising: a vibroseis truck having a metal plate configured to couple to a surface of the Earth and inject a ground force based on a pilot sweep; a vibroseis tool, operating on a computing platform, the vibroseis tool comprising: a vibroseis database operable to store the pilot sweep and a predetermined threshold; a vibroseis controller operable to receive recorded seismic data characterizing the ground force; a signal processor configured to: obtain a ground force signal from the recorded seismic data characterizing the ground force; extract a fundamental order harmonic signal and higher order harmonic signals from the ground force signal; compute an energy ratio for the ground force signal based on the fundamental order harmonic signal and higher order harmonic signals; and compare the energy ratio to the predetermined threshold.

Element 1: correlating the ground force signal with the pilot sweep in response to the energy ratio being less than the predetermined threshold. Element 2: wherein the second ground force and first ground force are injected into the subsurface environment at a common position based on the energy ratio of the first ground force. Element 3: wherein the first ground force is injected into the subsurface environment at a first position, the method further comprising injecting the second ground force at a second position in response to the energy ratio of the ground force signal being greater than the predetermined threshold. Element 4: wherein the predetermined threshold is 10%. Element 5: wherein the second ground force is injected based on the pilot sweep.

Element 6: wherein the ground force signal is a first ground force signal and the recorded seismic data is a first set of seismic data, the method further comprising: recording a second set of seismic data in response to injecting the second ground force to obtain a second ground force signal; and correlating the second ground force signal with the pilot sweep in response to the energy ratio of the second ground force signal being less than the predetermined threshold. Element 7: further comprising injecting a third ground force based on the pilot sweep at the second position in response to the energy ratio of the second ground force signal being less than the predetermined threshold.

Element 8: correlating the first ground force signal with the pilot sweep in response to the energy ratio being less than the predetermined threshold. Element 9: wherein the second ground force and first ground force are injected into the subsurface environment at a common position based on the energy ratio of the first ground force. Element 10: wherein the first ground force is injected into the subsurface environment at a first position, the method further comprising injecting the second ground force at a second position in response to the energy ration of the first ground force signal being greater than the predetermined threshold. Element 11: wherein the predetermined threshold is 10%.

Element 12: wherein the second ground force is injected based on the pilot sweep. Element 13: correlating a second ground force signal with the pilot sweep in response to the energy ratio being less than the predetermined threshold. Element 14: injecting a third ground force based on the pilot sweep at the second position in response to the energy ratio of the second ground force signal being less than the predetermined threshold. Element 15: wherein the ground force is injected to a surface of the Earth at a position by a vibroseis truck. Element 16: wherein the vibroseis truck injects another ground force at the position in response to the signal processor determining that the energy ratio is below the predetermined threshold. Element 17: wherein the vibroseis truck injects another ground force at another position in response to the signal processor determining that the energy ratio is above the predetermined threshold.

By way of non-limiting example, exemplary combinations applicable to A through C include: Element 1 with Element 2; Element 3 with Element 4; Element 4 with Element 5; Element 5 with Element 6; Element 6 with Element 7; Element 8 with Element 9; Element 10 with Element 11; Element 11 with Element 12; Element 12 with Element 13; Element 13 with Element 14; Element 12 with Element 13; Element 13 with Element 14; Element 15 with Element 16; and Element 15 with Element 17.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

The invention claimed is:

1. A method comprising:
injecting, by a vibroseis system, a first ground force into a subsurface environment based on a pilot sweep;
recording, by the vibroseis system, seismic data in response to the first ground force to obtain a ground force signal;
extracting, by the vibroseis system, a fundamental order harmonic signal and higher order harmonic signals from the ground force signal;
calculating, by the vibroseis system, an energy ratio based on the fundamental order harmonic signal and higher order harmonic signals;
comparing, by the vibroseis system, the energy ratio to a predetermined threshold; and
injecting, by the vibroseis system, a second ground force into the subsurface environment based on the comparison of the energy ratio to the predetermined threshold.

2. The method of claim 1, further comprising correlating the ground force signal with the pilot sweep in response to the energy ratio being less than the predetermined threshold.

3. The method of claim 2, wherein the second ground force and first ground force are injected into the subsurface environment at a common position based on the energy ratio of the first ground force.

4. The method of claim 1, wherein the first ground force is injected into the subsurface environment at a first position, the method further comprising injecting the second ground force at a second position in response to the energy ratio of the ground force signal being greater than the predetermined threshold.

5. The method of claim 4, wherein the predetermined threshold is 10%.

6. The method of claim 5, wherein the second ground force is injected based on the pilot sweep.

7. The method of claim 6, wherein the ground force signal is a first ground force signal and the recorded seismic data is a first set of seismic data, the method further comprising:
recording a second set of seismic data in response to injecting the second ground force to obtain a second ground force signal; and
correlating the second ground force signal with the pilot sweep in response to the energy ratio of the second ground force signal being less than the predetermined threshold.

8. The method of claim 7, further comprising injecting a third ground force based on the pilot sweep at the second position in response to the energy ratio of the second ground force signal being less than the predetermined threshold.

9. A machine-readable storage medium having stored thereon a computer program, the computer program comprising a routine of set instructions for causing a machine to perform the steps of:
injecting, by a metal plate, a first ground force into subsurface environment based on a pilot sweep;
receiving seismic data characterizing the first ground force based on the pilot sweep to obtain a first ground force signal;
extracting a fundamental order harmonic signal and higher order harmonic signals from the first ground force signal;
calculating an energy ratio of the first ground force signal based on the fundamental order harmonic signal and the higher order harmonic signals;
comparing the energy ratio of the first ground force signal to a predetermined threshold; and
injecting, by the metal plate, a second ground force into the subsurface environment based on the comparison of the energy ratio to the predetermined threshold.

10. The machine-readable storage medium of claim 9, further comprising correlating the first ground force signal with the pilot sweep in response to the energy ratio being less than the predetermined threshold.

11. The machine-readable storage medium of claim 10, wherein the second ground force and first ground force are injected into the subsurface environment at a common position based on the energy ratio of the first ground force.

12. The machine-readable storage medium of claim 9, wherein the first ground force is injected into the subsurface environment at a first position, the method further comprising injecting the second ground force at a second position in response to the energy ration of the first ground force signal being greater than the predetermined threshold.

13. The machine-readable storage medium of claim 12, wherein the predetermined threshold is 10%.

14. The machine-readable storage medium of claim 13, wherein the second ground force is injected based on the pilot sweep.

15. The machine-readable storage medium of claim 14, further comprising correlating a second ground force signal with the pilot sweep in response to the energy ratio being less than the predetermined threshold.

16. The machine-readable storage medium of claim 15, further comprising injecting a third ground force based on the pilot sweep at the second position in response to the energy ratio of the second ground force signal being less than the predetermined threshold.

17. A vibroseis system comprising:
a vibroseis truck having a metal plate configured to couple to a surface of the Earth and inject a ground force based on a pilot sweep;
a vibroseis tool, operating on a computing platform, the vibroseis tool comprising:
a vibroseis database operable to store the pilot sweep and a predetermined threshold;
a vibroseis controller operable to receive recorded seismic data characterizing the ground force;
a signal processor configured to:
obtain a ground force signal from the recorded seismic data characterizing the ground force;
extract a fundamental order harmonic signal and higher order harmonic signals from the ground force signal;
compute an energy ratio for the ground force signal based on the fundamental order harmonic signal and higher order harmonic signals; and
compare the energy ratio to the predetermined threshold.

18. The vibroseis system of claim 17, wherein the ground force is injected to a surface of the Earth at a position by a vibroseis truck.

19. The vibroseis system of claim 18, wherein the vibroseis truck injects another ground force at the position in response to the signal processor determining that the energy ratio is below the predetermined threshold.

20. The vibroseis system of claim 18, wherein the vibroseis truck injects another ground force at another position in response to the signal processor determining that the energy ratio is above the predetermined threshold.
